(19) United States
(12) Patent Application Publication
(10) Pub. No.: US 2018/0053148 A1
(43) Pub. Date: Feb. 22, 2018

(54) SYSTEM AND METHOD FOR SECURELY TRANSPORTING CARGO

(71) Applicant: Certainty Logistics LLC, Mobile, AL (US)

(72) Inventor: Max Rodgers Nelson, JR., Mobile, AL (US)

(73) Assignee: Certainty Logistics LLC, Mobile, AL (US)

(21) Appl. No.: 15/419,938

(22) Filed: Jan. 30, 2017

Related U.S. Application Data
(63) Continuation-in-part of application No. 15/242,550, filed on Aug. 21, 2016.

(51) Int. Cl. G06Q 10/08; G06K 7/10

(52) U.S. Cl. CPC G06Q 10/0833; G06K 7/10366

(57) ABSTRACT

A system and method for managing the delivery and tracking of bulk materials is provided. The system may provide for tracking deliveries through multiple parties involved in the process. The system verifies a chain of custody of the bulk materials between an origin vessel, a transportation container, and a delivery vessel. The system notifies a user whether the chain of custody is correct. The system may include web and phone versions allowing the user to scan identification codes associated with specific origin vessels, delivery vessels, and transport containers, and store information relating to those identification codes for later access as a unit of information relating to a load of goods being delivered.

### CROSS REFERENCES

This application is a continuation-in-part of prior U.S. application Ser. No. 15/242,550, filed on Aug. 21, 2016, currently pending, which application is incorporated herein by reference.

### FIELD OF THE INVENTION

The present disclosure refers generally to a system and method for managing the shipping and tracking of bulk materials.

### BACKGROUND

Currently the delivery process that involves delivery of bulk materials is a very detailed process that requires several checks of tanker tags, Bills of Lading, Carrier paperwork and delivery tank placarding. Personnel are required to determine which of one of many possible tanks should receive an incoming delivery load. This is a labor intensive job requiring many manual inputs. In some cases, specific information regarding the specifics of a tank may not be known. As such, whether to load and offload a particular material into or out of an unknown tank may be a subjective decision.

In some places, administrative controls have been implemented to help aid in the process. However, there are limited engineering controls that maintain the chain of custody through the supplier, transporter and end user. Current procedures use paperwork inspection and manual locking valves on the unload site. However, the current method does not account for errors in paperwork, accidental receipt of incorrect paperwork, or other errors.

Accordingly, there is a need for an improved system and method for verifying that a correct chain of custody exists between a specific origin vessel, specific transport container, and specific delivery vessel.

### SUMMARY

In accordance with the present disclosure, a system and method for managing the delivery and tracking of bulk materials are provided. The system may provide for tracking deliveries through multiple parties involved in the process of transporting bulk materials. The system and method may include web and mobile phone versions. The system may be implemented on a mobile phone application.

Generally, information relating to a load of goods to be delivered is grouped together and stored in a database. The information may include origin vessel number, vessel location, chemical name of the goods, hazard category, or other pertinent information relating to a load of goods. Custody of the load of goods is transferred for delivery from an origin vessel to a delivery vessel via a transport container. A user may scan a barcode that is associated with the transport container, and this information is then grouped to the load of goods. The user may then access the system and select a drop-off location based on potential options that contain the same goods as the load. The load of goods may then be transported for delivery to the delivery vessel.

Upon arriving at a drop-off location, a similar vessel identification code is scanned to initiate a load validation process. The user scans the identification code associated with the transport container at the drop-off location. The system then confirms the chain of custody ensuring that the goods from the origin vessel, to the transport container, and to the delivery vessel all match. Upon receipt of confirmation from the database, the system sends a signal to a user device that indicates whether the chain of custody is correct. If the signal indicates that the chain of custody is correct, then a user may initiate offloading of the load of goods into the delivery vessel. If the signal indicates that the chain of custody is incorrect, then the user can take appropriate steps to establish a correct chain of custody before offloading the load of goods into the delivery vessel.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### DESCRIPTION OF THE DRAWINGS

These and other features, aspects, and advantages of the present invention will become better understood with regard to the following description, appended claims, and accompanying drawings where:

FIG. 1 is a diagram of an example environment in which techniques described herein may be implemented;

FIG. 2 is an exemplary diagram of a client of FIG. 1 according to an implementation consistent with the principles of the invention;

FIG. 3 is a diagram of an example of a computing device and a mobile computing device;

FIG. 4 is a diagram illustrating an example system configuration according to an implementation consistent with the principles of the invention;

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

Systems and methods consistent with the principles of the invention may provide solutions for managing loading, shipping, delivery, and tracking of bulk goods. For example, the systems and methods may permit users to load, ship, deliver, and track hazardous chemicals.

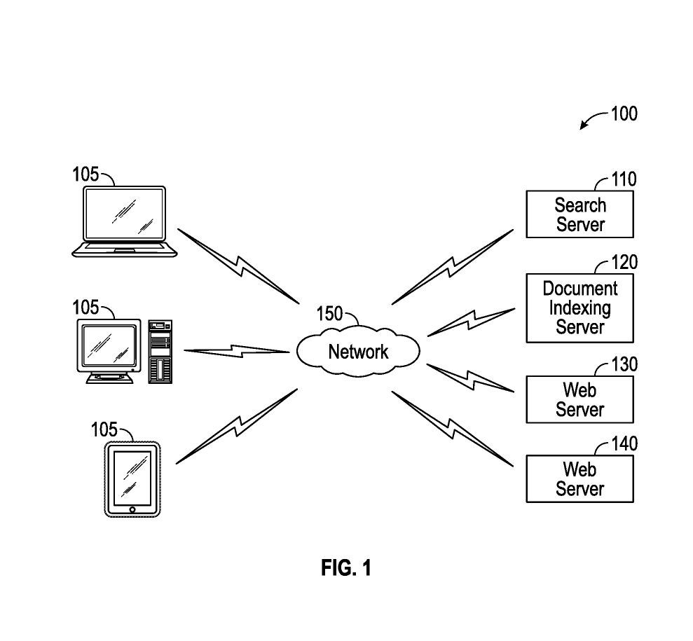

FIG. 1 is a diagram of an example environment 100 in which techniques described herein may be implemented. Environment 100 may include multiple clients 105 connected to one or more servers 110-140 via a network 150. In some implementations, and as illustrated, server 110 may be a search server, that may implement a search engine; and server 120 may be a document indexing server, e.g., a web crawler; and servers 130 and 140 may be general web servers, such as servers that provide content to clients 105. Clients 105 and servers 110-140 may be connected to network 150 via wired, wireless, or a combination of wired and wireless connections.

Three clients 105 and four servers 110-140 are illustrated as connected to network 150 for simplicity. In practice, there may be additional or fewer clients and servers. Also, in some instances, a client may perform the functions of a server and a server may perform the functions of a client.

Clients 105 may include devices of users that access servers 110-140. A client 105 may include, for instance, a personal computer, a wireless telephone, a personal digital assistant (PDA), a laptop, a smart phone, a tablet computer, or another type of computation or communication device. Servers 110-140 may include devices that access, fetch, aggregate, process, search, provide, and/or maintain documents. Although shown as single components 110, 120, 130, and 140 in FIG. 1, each server 110-140 may, in some implementations, be implemented as multiple computing devices, which potentially may be geographically distributed.

Search server 110 may include one or more computing devices designed to implement a search engine, such as a documents/records search engine, general webpage search engine, etc. Search server 110 may, for example, include one or more web servers to receive search queries and/or inputs from clients 105, search one or more databases in response to the search queries and/or inputs, and provide documents or information, relevant to the search queries and/or inputs, to clients 105. In some implementations, search server 110 may include a web search server that may provide webpages to clients 105, where a provided webpage may include a reference to a web server, such as one of web servers 130 or 140, at which the desired information and/or links is located. The references, to the web server at which the desired information is located, may be included in a frame and/or text box, or as a link to the desired information/document.

Document indexing server 120 may include one or more computing devices designed to index documents available through network 150. Document indexing server 120 may access other servers, such as web servers that host content, to index the content. In some implementations, document indexing server 120 may index documents/records stored by other servers, such as web servers 130 and 140, connected to network 150. Document indexing server 120 may, for example, store and index content, information, and documents relating to bulk good loading shipping, tracking, and offloading.

Web servers 130 and 140 may each include web servers that provide webpages to clients. The webpages may be, for example, HTML-based webpages. A web server 130/140 may host one or more websites. A website, as the term is used herein, may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

While servers 110-140 are shown as separate entities, it may be possible for one or more servers 110-140 to perform one or more of the functions of another one or more of servers 110-140. For example, it may be possible that two or more of servers 110-140 are implemented as a single server. It may also be possible for one of servers 110-140 to be implemented as multiple, possibly distributed, computing devices.

Network 150 may include one or more networks of any kind, including, but not limited to, a local area network (LAN), a wide area network (WAN), a telephone network, such as the Public Switched Telephone Network (PSTN), an intranet, the Internet, a memory device, another type of network, or a combination of networks.

Although FIG. 1 shows example components of environment 100, in other implementations, environment 100 may contain fewer components, different components, differently arranged components, and/or additional components than those depicted in FIG. 1. Alternatively, or additionally, one or more components of environment 100 may perform one or more other tasks described as being performed by one or more other components of environment 200.

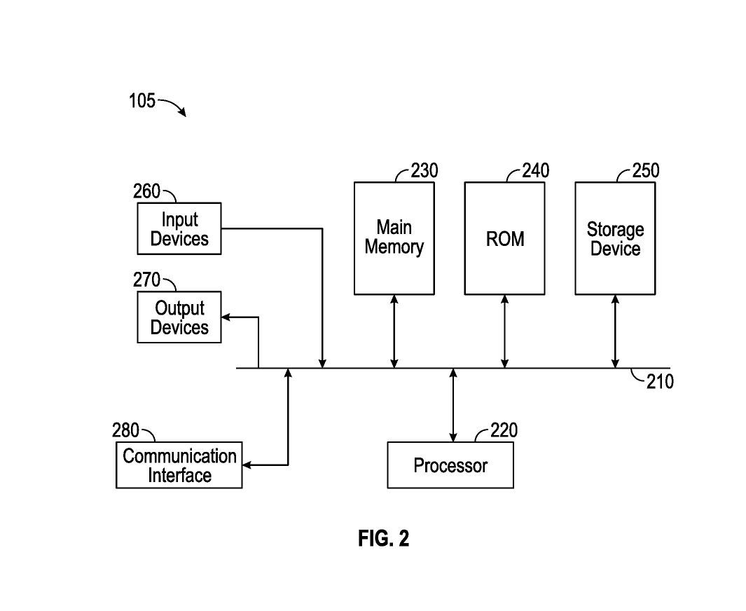

FIG. 2 is an exemplary diagram of a user/client 105 or server entity (hereinafter called “client/server entity”), which may correspond to one or more of the clients and servers, according to an implementation consistent with the principles of the invention. The client/server entity 105 may include a bus 210, a processor 220, a main memory 230, a read only memory (ROM) 240, a storage device 250, one or more input devices 260, one or more output devices 270, and a communication interface 280. Bus 210 may include one or more conductors that permit communication among the components of the client/server entity 105.

Processor 220 may include any type of conventional processor or microprocessor that interprets and executes instructions. Main memory 230 may include a random access memory (RAM) or another type of dynamic storage device that stores information and instructions for execution by processor 220. ROM 240 may include a conventional ROM device or another type of static storage device that stores static information and instructions for use by processor 220. Storage device 250 may include a magnetic and/or optical recording medium and its corresponding drive.

Input device(s) 260 may include one or more conventional mechanisms that permit an operator to input information to the client/server entity 105, such as a scanner, phone, camera, scanning device, keyboard, a mouse, a pen, voice recognition and/or biometric mechanisms, etc. Output device(s) 270 may include one or more conventional mechanisms that output information to the operator, including a display, a printer, a speaker, an alarm, a valve, an actuator, etc. Communication interface 280 may include any transceiver-like mechanism that enables the client/server entity 105 to communicate with other devices 105 and/or systems. For example, communication interface 280 may include mechanisms for communicating with another device 105 or system via a network, such as network 150.

As will be described in detail below, the client/server entity 105, consistent with the principles of the invention, performs certain search, recording, and tracking operations. The client/server entity 105 may perform these operations in response to processor 220 executing software instructions contained in a computer-readable medium, such as memory 230. A computer-readable medium may be defined as one or more physical or logical memory devices and/or carrier waves.

The software instructions may be read into memory 230 from another computer-readable medium, such as data storage device 250, or from another device via communication interface 280. The software instructions contained in memory 230 causes processor 220 to perform processes that will be described later. Alternatively, hardwired circuitry may be used in place of or in combination with software instructions to implement processes consistent with the principles of the invention. Thus, implementations consistent with the principles of the invention are not limited to any specific combination of hardware circuitry and software.

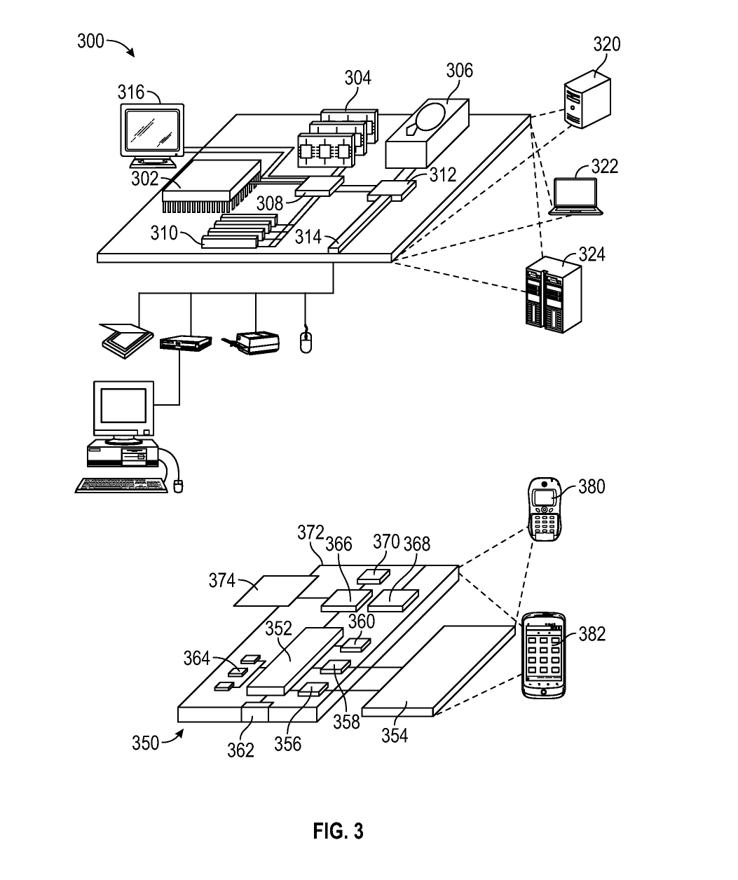

FIG. 3 is a diagram of an example of a computing device 300 and a mobile computing device 350, which may be used with the techniques described here. Computing device 300 or mobile computing device 350 may correspond to, for example, a client 205 and/or a server 210-240. Computing device 300 is intended to represent various forms of digital computers, such as laptops, desktops, workstations, personal digital assistants, servers, mainframes, and other appropriate computers. Mobile computing device 350 is intended to represent various forms of mobile devices, such as scanners, scanning devices, personal digital assistants, cellular telephones, smart phones, tablet computers, and other similar computing devices. The components shown in FIG. 3, their connections and relationships, and their functions, are meant to be examples only, and are not meant to limit implementations described herein.

Computing device 300 may include a processor 302, a memory 304, a storage device 306, a high-speed interface 308 connecting to a memory 304 and high-speed expansion ports 310, and a low-speed interface 312 connecting to a low-speed expansion port 314 and a storage device 306. Each of components 302, 304, 306, 308, 310, 312, and 314 are interconnected using various buses, and may be mounted on a common motherboard or in other manners as appropriate. Processor 302 can process instructions for execution within computing device 300, including instructions stored in memory 304 or on storage device 306 to display graphical information for a graphical user interface (GUI) on an external input/output device, such as display 316 coupled to high-speed interface 308. In other implementations, multiple processors and/or multiple buses may be used, as appropriate, along with multiple memories and types of memory. Also, multiple computing devices 300 may be connected, with each device providing portions of the necessary operations, as a server bank, a group of blade servers, or a multi-processor system, etc.

Memory 304 stores information within computing device 300. In some implementations, memory 304 includes a volatile memory unit or units. In another implementation, memory 304 may include a non-volatile memory unit or units. Memory 304 may also be another form of computer-readable medium, such as a magnetic or optical disk. A computer-readable medium may refer to a non-transitory memory device. A memory device may refer to storage space within a single storage device or spread across multiple storage devices.

Storage device 306 is capable of providing mass storage for computing device 300. In some implementations, storage device 306 may be or contain a computer-readable medium, such as a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described herein. The information carrier is a computer or machine-readable medium, such as memory 304, storage device 306, or a memory on processor 302.

High-speed interface 308 manages bandwidth-intensive operations for computing device 300, while low-speed interface 312 manages lower bandwidth-intensive operations. Such allocation of functions is an example only. In some implementations, high-speed interface 308 is coupled to memory 304, display 316, such as through a graphics processor or accelerator, and to high-speed expansion ports 310, which may accept various expansion cards. In this implementation, low-speed interface 312 may be coupled to storage device 306 and low-speed expansion port 314. Low-speed expansion port 314, which may include various communication ports, such as USB, Bluetooth, Ethernet, wireless Ethernet, etc., may be coupled to one or more input/output devices, such as a keyboard, a pointing device, a scanner, or a networking device such as switch or router, e.g., through a network adapter.

Computing device 300 may be implemented in a number of different forms, as shown in the figures. For example, computing device 300 may be implemented as a standard server 320, or in a group of such servers. Computing device 300 may also be implemented as part of a rack server system 324. In addition, computing device 300 may be implemented in a personal computer, such as a laptop computer 322. Alternatively, components from computing device 300 may be combined with other components in a mobile device, such as mobile computing device 350. Each of such devices may contain one or more computing devices 300, 350, and an entire system may be made up of multiple computing devices 300, 350 communicating with each other.

Mobile computing device 350 may include a processor 352, a memory 364, an input/output (“I/O”) device, such as a display 354, a communication interface 366, and a transceiver 368, among other components. Mobile computing device 350 may also be provided with a storage device, such as a micro-drive or other device, to provide additional storage. Each of the components 352, 364, 354, 366, and 368 are interconnected using various buses, and several of the components may be mounted on a common motherboard or in other manners as appropriate.

Processor 352 can execute instructions within mobile computing device 350, including instructions stored in memory 364. Processor 352 may be implemented as a chipset of chips that include separate and multiple analog and digital processors. Processor 352 may provide, for example, for coordination of the other components of mobile computing device 350, such as control of user interfaces, applications run by mobile computing device 350, and wireless communication by mobile computing device 350.

Processor 352 may communicate with a user through control interface 358 and display interface 356 coupled to a display 354. Display 354 may be, for example, a TFT LCD (Thin-Film-Transistor Liquid Crystal Display) or an OLED (Organic Light Emitting Diode) display or other appropriate display technology. Display interface 356 may include appropriate circuitry for driving display 354 to present graphical and other information to a user. Control interface 358 may receive commands from a user and convert the commands for submission to processor 352. In addition, an external interface 362 may be provided in communication with processor 352, so as to enable near area communication of mobile computing device 350 with other devices. External interface 362 may provide, for example, for wired communications in some implementations, or for wireless communication in other implementations, and multiple interfaces may also be used.

Memory 364 stores information within mobile computing device 350. Memory 364 can be implemented as one or more of a computer-readable medium or media, a volatile memory unit or units, or a non-volatile memory unit or units. Expansion memory 374 may also be provided and connected to mobile computing device 350 through expansion interface 372, which may include, for example, a SIMM (Single In Line Memory Module) card interface. Such expansion memory 374 may provide extra storage space for device 350, or may also store applications or other information for mobile computing device 350. Specifically, expansion memory 374 may include instructions to carry out or supplement the processes described herein, and may include secure information also. Thus, for example, expansion memory 374 may be provided as a security module for mobile computing device 350, and may be programmed with instructions that permit secure use of mobile computing device 350. In addition, secure applications may be provided via the SIMM cards, along with additional information, such as placing identifying information on the SIMM card in a non-hackable manner.

Expansion memory 374 may include, for example, flash memory and/or NVRAM memory. In some implementations, a computer program product is tangibly embodied in an information carrier. The computer program product contains instructions that, when executed, perform one or more methods, such as those described herein. The information carrier may be a computer-readable or machine-readable medium, such as memory 364, expansion memory 374, or a memory on processor 352, that may be received, for example, over transceiver 368 or external interface 362.

Mobile computing device 350 may communicate wirelessly through communication interface 366, which may include digital signal processing circuitry where necessary. Communication interface 366 may provide for communications under various modes or protocols, such as GSM voice calls, SMS, EMS or MMS messaging, CDMA, TDMA, PDC, WCDMA, CDMA2000, or GPRS, among others. Such communication may occur, for example, through transceiver 368. In addition, short-range communication may occur, such as using a Bluetooth, WiFi, or other such transceiver. In addition, GPS (Global Positioning System) received module 370 may provide additional navigation-related and location-related wireless data to mobile computing device 350, which may be used as appropriate by applications running on mobile computing device 350.

Mobile computing device 350 may also communicate audibly using audio codec 360, which may receive spoken information from a user and covert the received spoken information to digital information. Audio codec 360 may likewise generate audible sound for a user, such as through a speaker, e.g., in a handset of mobile computing device 350. Such sound may include sound from voice telephone calls, may include recorded sound, such as voice messages, music files, etc., and may also include sound generated by applications operating on mobile computing device 350.

Mobile computing device 350 may be implemented in a number of different forms, as shown in the figure. For example, mobile computing device 350 may be implemented as a cellular telephone 380. Mobile computing device 350 may also be implemented as part of a smart phone 382, personal digital assistant, or other similar mobile device.

Various implementations described herein can be realized in digital electronic circuitry, integrated circuitry, specially designed ASICs (application specific integrated circuits), computer hardware, firmware, software, and/or combinations thereof. These various implementations can include implementations in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications, or code, include machine instructions for a programmable processor, and can be implemented in a high-level procedural and/or object-oriented programming language, and/or in assembly/machine language. As used herein, the terms “machine-readable medium” and “computer-readable medium” refer to any apparatus and/or device, such as magnetic discs, optical disks, memory, Programmable Logic Devices (“PLDs”), used to provide machine instructions and/or data to a programmable processor, including a machine-readable medium that receives machine instructions as a machine-readable signal. The term “machine-readable signal” refers to any signal used to provide machine instructions and/or data to a programmable processor.

The contents of computer-readable medium may physically reside in one or more memory devices accessible by server. Computer-readable medium may include a database of entries corresponding to loading, shipping, offloading, tracking, and customer management. Each of the entries may include, but are not limited to, shipping organization, shipped product, receiving organization, quantity, quantity type, reference number, type, comments, loading date, delivery date, and other fields. The information fields store in a database a user or organization's information as set forth herein. Said fields are customizable and may include additional or alternative fields based on the user's needs. Said information is accessible through the server.

To provide for interaction with a user, the techniques described herein can be implemented on a computer having a display device, such as a CRT (cathode ray tube), LCD (liquid crystal display), or LED (Light Emitting Diode) monitor, for displaying information to the user and a keyboard and a pointing device by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

The techniques described herein can be implemented in a computing system that includes a back end component, such as a data server, or that includes a middleware component, such as an application server, or that includes a front end component, such as a client computer having a graphical user interface or Web browser through which a user can interact with an implementation of the techniques described here, or any combination of such back end, middleware, or front end components. The components of the system can be interconnected by any form of medium of digital communication.

In accordance with the present disclosure, a system and method for managing the delivery of bulk materials are provided. The system may provide for tracking deliveries of goods through multiple parties involved in the process of transporting and delivering goods. The system provides for automated verification of a chain of custody of a load of goods being delivered and notifies a user whether the chain of custody is correct.

Consistent with the disclosure set forth herein, the system and method may include web and mobile phone versions. The system may be implemented on a mobile phone application. A user may utilize a smartphone and scan an identification code using the camera function on the smartphone. In addition, a traditional barcode scanner may be utilized. It is understood that, consistent with the present disclosure, any device for scanning a bar code may be utilized. As described below, information relating to a load of goods to be delivered is grouped together and stored in a database. The information may include origin vessel number, vessel location, chemical name of the goods, hazard category, or other pertinent information relating to a load of goods. Thus, a “load” may be created in the database containing information pertinent to load of goods. Custody of the load of goods is transferred for delivery from an origin vessel to a delivery vessel via a transport container. The transfer of custody may be to a third party transport company. A user scans an identification code, which may be a barcode, that is associated with the transport container, and this information is grouped to the load of goods. The user may then access the system and select a drop-off location based on potential options that have a delivery vessel containing the same type of goods, such as bulk chemicals, as the load. The load of goods may then be transported for delivery to the delivery vessel. Optionally, barcodes or other types of identification codes may be replaced with GPS tags, RFID tags, and the like.

As used herein, information being “grouped to a load of goods” indicates that all information relating to a particular load of goods is grouped together so that all of the information may be accessed as a unit. The information grouped to a load of goods includes information relating to the origin vessel, the transport container, and the delivery vessel, and may contain additional information pertinent to the load of goods being delivered.

Upon arriving at a drop-off location, a similar vessel identification code is scanned to initiate a load validation process. The drop-off location may be an industrial facility, warehousing or offloading facility, or any similar type of facility or location having at least one delivery vessel for receiving bulk goods. At the drop-off location, the user scans the identification code associated with the transport container. The system then verifies the chain of custody ensuring that the goods from the origin vessel, to the transport container, to the delivery vessel all match. Upon receipt of verification from the database, the system sends a signal to a user device. The signal is responsive to the verification of the chain of custody and indicates to a user whether the chain of custody is correct. The user device may be a smartphone, tablet, notebook or desktop computer, scanner, or similar type of electronic device, which may be a network or internet connected device, capable of receiving a signal. The signal may be in the form of an automated message, an SMS message, an email, or any other type of signal that indicates whether the chain of custody is correct or incorrect. The user device may additionally function as a scanning device configured for scanning identification codes, such as barcodes, associated with origin vessel, transport container, or delivery vessel. The user device is preferably a portable device, but may alternatively be mounted on or in close proximity to a delivery vessel for receiving bulk goods, or may be located adjacent to a valve located on a supply line to a delivery vessel.

If the signal indicates that the chain of custody is correct, then a user may initiate offloading of the load of goods into the delivery vessel. Initiating offloading may be done by opening a valve on a supply line to the delivery vessel into which the goods will be transferred, by connecting an offloading hose from the transport container to the delivery vessel for transferring the goods, or by any similar method of transferring bulk goods from a transport container into a delivery vessel, which may be done manually or by automation. If the signal indicates that the chain of custody is incorrect, then the user can take appropriate steps to establish a correct chain of custody before offloading the load of goods into the delivery vessel.

As described below, the use of smartphone technology may allow for all scanning of identification codes to take place at the point of action as opposed to entering information into a remote data entry device, or bringing paperwork from a remote office. Additionally, the hardware set forth herein may allow for information to be passed through a data center directly from a load site to an offload site without any human interface, thereby eliminating the potential for error. This moves the process from administrative controls to engineering controls, which is generally preferred with any safety system. Nonetheless, systems and methods set forth herein may function without using a smartphone.

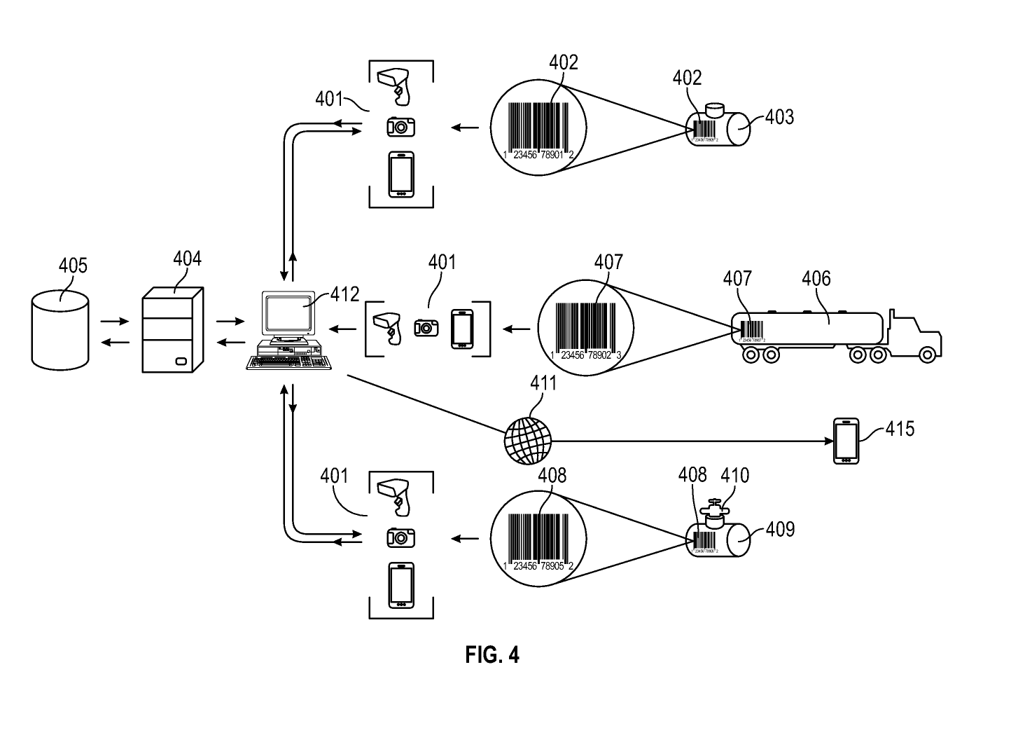

In accordance with the present disclosure, a method for delivering and tracking cargo, such as bulk goods, is provided. As illustrated in FIG. 4, a user uses a scanning device 401 to scan a first identification code 402 associated with an origin vessel 403 holding goods to be delivered to a drop-off location. The first identification code 402 may be attached to the origin vessel 403. However, the first identification code 402 may also be removable or not directly connected to the origin vessel 403. For example, the first identification code 402 may be a placard or card that a delivery driver carries inside of a vehicle used for transport. Thus, the driver may have a unique identification code 402 for a load of goods that he is carrying, but the identification code 402 may not be attached to the origin vessel 403. Once scanned, a server 404 will retrieve information relating to the origin vessel from a database 405. This information may include a chemical name, class, cost, expiration date, or toxicity of goods stored therein, storage site, GPS coordinates, or other similar data. The various information and data relating to the origin vessel and the goods contained therein are then stored in the database 405. This information is grouped together and stored in the database so that other information relating to the delivery of a particular load of goods may be later grouped together with the previously stored information. Thus, all of the stored information pertinent to a particular load of goods, including information relating to the origin vessel, the transport container, and the delivery vessel, is grouped together so that all of the information may be accessed as a unit.

Next, a chain of custody from the origin vessel 403 to a transport container 406 is created. A user uses a scanning device 401 to scan a second identification code 407 associated with a transport container 406. The second identification code 407 may be removable and not connected to the transport container 406. For example, the second identification code 407 may be a placard or card that the delivery driver carries inside of a transport vehicle. In this way, the driver may have a unique identification code 407 for the transport container 406 he is transporting.

Once scanned, a server 404 retrieves information relating to the transport container 406. This information may relate to the type of container, capacity of the container, storage limitations or restrictions, or other similar data. The system stores the information and data relating to the transport container in a database 405. This information is then grouped to the same load of goods from the origin vessel. Thus, the information associated with the origin vessel 403 and the transport container 406 are grouped to the load of goods to be delivered.

Before proceeding with a delivery of a load of goods, a user may optionally retrieve one or more available drop-off locations for delivering the load of goods. The available drop-off locations may be pre-populated in the system or may be uploaded by a user. A user may then select one of the drop-off locations. The system may store information relating to the drop-off location in the database 405. This information may include address, hours of operation, number of delivery vessels, delivery vessel information, chemical types accepted, or other similar data. The drop-off location information and data is then grouped to the load of goods. In this way, the information associated with the origin vessel 403, the transport container 406, and the drop-off location may be grouped to the load of goods.

The load of goods is transported to the selected drop-off location, and a third identification code 408 associated with a delivery vessel 409 is scanned. The third identification code 408 may be removable and may not be connected to the delivery vessel 409. The system retrieves information relating to the delivery vessel 409. The information relating to the delivery vessel may include vessel capacity, chemical compatibility, GPS coordinates, or other similar data. The system stores information relating to the delivery vessel 409 in a database 405. This information is then grouped to the load of goods. In this way, the information associated with the origin vessel 403, the transport container 406, the drop-off location, and the delivery vessel 409 may be grouped to the load of goods.

Before a delivery is completed, a transport container will arrive at the drop-off location, where a user using a scanning device 401 scans the second identification code 407 associated with the transport container 406. The system uses the scans of the identification code 407 of the transport container 406 to verify that a chain of custody exists with the load of goods. A correct chain of custody is the pre-set custody of a load of goods from a selected origin vessel, to a selected transport container, to a selected delivery vessel, as identified by scanning the third identification code 408 associated with the delivery vessel 409. This information is stored in a database and grouped to the specific load of goods. If a correct chain of custody exists, the user will receive a signal indicating that the chain of custody is correct. The user may then initiate the transfer or offloading of the goods from the transport container 406 to the delivery vessel 409. The signal is sent to a user device 415, which may be a smartphone or similar portable electronic device. The signal may be sent via a network 411, which may be an internet, telephone, cellular, or other similar network for communicating information. Initiating offloading may be done by opening a valve 410 on a supply line to the delivery vessel 409 into which the goods will be transferred, which may be done manually or by automation.

If the chain of custody is incorrect, the user will receive a signal indicating that the chain of custody is incorrect. The signal is sent to the user device 415. Upon receipt of signal on the user device 415 indicating an incorrect chain of custody, the user can then take appropriate steps to establish a correct chain of custody before offloading the load of goods into a delivery vessel in accordance with an established chain of custody that is correct. The final outcome of a correct or incorrect chain of custody may be stored in the database 405 and grouped to the load of goods. In a preferred embodiment, the user device 415 may also function as a scanning device 401 such that a single device may be used for scanning identification codes 402, 407, and 408 and for receiving a signal indicating whether the chain of custody is correct or incorrect. In a preferred embodiment, a smartphone may be used as both the scanning device 401 and the user device 415.

Information relating to a load of goods may include information relating to an origin vessel identification code 402, an origin vessel 403, a transport container identification code 407, a transport container 406, a delivery vessel identification code 408, a delivery vessel 409, an origin vessel location, a transport container location, a transport offload hose location, a delivery vessel location, information relating to whether a delivery vessel has sufficient space in the delivery vessel to accept a load, a chemical name, a hazard category, or other similar information.

Barcodes may be utilized for scanning the identification codes. As used herein, barcodes are optical, machine-readable, representations of data. The data describes something about the object associated with the barcode. Barcodes may systematically represent data by varying the widths and spacing of parallel lines, and may be referred to as linear or one-dimensional (1D). Additionally, two-dimensional (2D) codes may be used, using rectangles, dots, hexagons and other geometric patterns in two dimensions. These barcodes may be scanned by special optical scanners called barcode readers or by utilizing devices such as smartphones with cameras.

Alternatively, RFID tags may be utilized for scanning the identification codes. Radio-frequency identification (RFID) uses electromagnetic fields to automatically identify and track tags attached to objects. The tags contain electronically stored information. Passive tags collect energy from a nearby RFID reader's interrogating radio waves. Active tags have a local power source such as a battery and may operate at hundreds of meters from the RFID reader. Identification codes may also be scanned using a global positioning system tracking device. Optionally, the origin vessel, delivery vessel, or transport container identification codes may include global positioning system (GPS) coordinates or GPS tracking devices.

In accordance with the present disclosure, a method for accurately delivering cargo, such as bulk goods, is provided. As illustrated in FIG. 4, information relating to origin vessel 403, delivery vessel 409, and transport container 406 is stored in a database 405. This information relates to a specific origin vessel 403, a specific delivery vessel 409, and a specific transport container 406, respectively. Information relating to a plurality of origin vessels, delivery vessels, and transport containers may be stored in the database 405 for selection of a specific origin vessel, delivery vessel, or transport container. Alternatively, a user may upload information relating to specific vessels and transport containers into the system.

Unique identification codes for each of the vessels and transport containers are provided by the system. The unique identification codes may include data relating to each of the specific vessels and transport containers. This data may include chemical storage, transportation, and capacity information.

Once a user is ready to begin transporting a load of goods, the user scans the unique identification code 402 of the origin vessel 403. Once scanned, the system stores information relating to the origin vessel in a database 405, and the information is grouped to a load of goods. Next, a user scans a unique identification code 407 of a transport container 406. Once scanned, the system stores information relating to the transport container in a database 405, and the information is grouped to the load of goods. Once the origin vessel 403 and transport container 406 are associated with a load, a user may load the transport container 406 with goods from the origin vessel 403.

Once the goods are loaded, they are transported from the origin vessel 403 to a drop-off location where the delivery vessel 409 is located for offloading the goods into the delivery vessel 409. The transport container 406 may be equipped with a GPS device. The location of the transport container 406 may be tracked, and information relating to the tracking may be grouped to the load of goods and stored in the database 405.

Before offloading the goods into the delivery vessel 409 at the drop-off location, a user utilizing a scanning device 401 scans the identification code 408 of the delivery vessel 409. The system stores information relating to the delivery vessel 409 in the database 405, and the stored information is grouped to the load. The system then analyzes whether a correct chain of custody exists between the origin vessel 403, transport container 406, and delivery vessel 409. As set forth herein, a correct chain of custody exists if each of the origin vessel 403, transport container 406, and delivery vessel 409 are the pre-selected respective vessels and containers. Depending on the chain of custody, the system may send a signal to a user device 415 indicating whether the chain of custody is correct or incorrect.

If there is a correct chain of custody from the origin vessel, to the transport container, to the delivery vessel, the system may store the occurrence of a positive chain of custody in the database. If there is an incorrect chain of custody from the origin vessel, to the transport container, to the delivery vessel, the system may store information relating to the incorrect chain of custody in the database. This stored information will be grouped to the load. The signal sent to the user via the user device 415 will inform the user whether the user should initiate offloading of the goods into the delivery vessel 409 or whether the user should take necessary steps to establish a correct chain of custody.

In accordance with the present disclosure, a system may comprise a processor and a non-transitory computer-readable medium for controlling shipments of bulk goods. The non-transitory computer-readable medium is coupled to the processor and has instructions stored thereon, which, when executed by the processor, cause the processor to perform certain operations. The operations may comprise receiving, from a scanning device 401, data responsive to scanning a first identification code 402 associated with an origin vessel 403, wherein information relating to the first identification code 402 is provided and stored. Furthermore, the operations may comprise, receiving, from a scanning device 401, data responsive to scanning a second identification 407 code associated with a transport container 406, wherein information relating to the second identification code 407 is provided and stored. The operations may further comprise receiving, from a scanning device 401, data responsive to scanning a third identification code 408 associated with a delivery vessel 409, wherein information relating to the third identification code 408 is provided and stored. The operations may further comprise sending a signal to a user device 415, which may also function as a scanning device 401, wherein the signal is responsive to verifying the chain of custody, and wherein the signal indicates whether the chain of custody is correct. The operations may further comprise verifying, by the processor 412, a chain of custody between the origin vessel 403, the transport container 406, and the delivery vessel 409. The operations may further comprise storing all information relating to the identification codes and to the chain of custody, and storing information relating to an action taken in response to the stored information relating to the identification codes and the chain of custody in a database 405.

The system set forth herein may further comprise a user management system allowing an administrator to group users by individual organizations or entities and limit their access to only specific vessel and container information for their organization or entity, or setup system-wide users who manage the overall network. The system may further comprise a comprehensive shipment management system that tracks all of the information passing through the system and makes it available for later use. The system may further comprise reporting tools to export useful analytics from the system in various formats including HTML and Excel.

The system may be written in C# and utilize Microsoft ASP.NET, or may be created from any language using any framework. The system may comprise a suite of web services that power all of the applications and tools making up the system. For example, web-based management tools, as well as the web-based delivery application, may both interface with the same set of services.

The system may utilize a database management system such as Microsoft SQL or similar. Various types of servers may be used to access stored data. Users may connect through a service or server before accessing stored data. This ensures all access to the database has been authenticated and restricts users to changes within their organization or entity, as set forth herein.

A user may use a web browser to navigate to a system website. The system website may comprise a plurality of web pages. Each webpage may be accessed via tabs on a system website homepage or other system webpage. Links or tabs may allow a user to navigate from one page to another. The system may further comprise web-based forms with text fields therein. The text fields may auto populate predetermined forms, webpages, databases, servers, or other targeted destinations. A user may access a webpage that accesses a database via a server.

Users with required permission levels may access a system reporting interface. The system reporting interface may consolidate organization or entity information and may allow a user to filter information based on specific fields, sales, and other relevant categories. This information may be stored in a system database. The system and method set forth herein may find utility in many areas in which controlled delivery of goods is desired, and particularly the delivery of bulk goods. The system may find particular utility in the field associated with delivery and tracking of expensive and toxic chemicals. For example, a manufacturer may desire to transport one-thousand liters of hydrochloric acid from its manufacturing facility to a client. Due to the dangerous and toxic nature of hydrochloric acid, it is imperative that the containers and vessels be configured to accept the acid. For example, the origin vessel at the manufacturing facility may have an identification code that includes information showing the chemical contained therein is the proper chemical—hydrochloric acid. Next, before loading the chemical onto the transport container, the user will scan an identification code of the designated transport container. The identification code will have information relating to the type of chemicals that may be transported therein. If the system recognizes that the transport container is situated to receive the goods, the system will recognize a positive chain of custody. The system verifies that the chain of custody is correct and alerts a user that the chain of custody is correct. The chemical is then loaded into the transport container and transported to a drop-off location where a delivery vessel is located. The user scans the identification code of the delivery vessel to verify that the vessel is the designated vessel for the delivery and is configured to receive the specific chemicals. If the chain of custody is correct, the user will receive a notification that the chain of custody is correct, and the user may then initiate offloading of the chemical. The chemical may then be offloaded into the delivery vessel. If the chain of custody is incorrect, the user will receive a notification that the chain of custody is incorrect, and the user may take any steps necessary to establish a correct chain of custody before offloading the goods into a delivery vessel.

It will also be apparent to one of ordinary skill in the art that aspects of the present disclosure, as described above, may be implemented in many different forms of software, firmware, and hardware in the implementations illustrated in the figures. The actual software code or specialized control hardware used to implement aspects consistent with the present disclosure is not limiting. Thus, the operation and behavior of the aspects were described without references to the specific software code—it being understood that one of ordinary skill in the art would be able to design software and control hardware to implement the aspects based on the description herein.

What is claimed is:

1. A method for delivering goods, said method comprising:
a. Scanning a first identification code associated with an origin vessel containing goods,
b. Retrieving, by a server, information relating to the origin vessel,
c. Storing said information relating to the origin vessel in a database, wherein the stored information relating to the origin vessel is grouped to a load of goods,
d. Scanning a second identification code associated with a transport container,
e. Retrieving, by a server, information relating to the transport container,
f. Storing said information relating to the transport container in the database, wherein the stored information relating to the transport container is grouped to the load of goods,
g. Retrieving, by a server from the database, one or more available drop-off locations for delivering the load of goods;
h. Selecting a drop-off location;
i. Storing information relating to the selected drop-off location in the database, wherein the stored information relating to the selected drop-off location is grouped to the load of goods;
j. Transporting the load of goods to the selected drop-off location in the transport container;
k. Scanning, at the drop-off location, a third identification code associated with a delivery vessel;
l. Retrieving, by the server, information relating to the delivery vessel;
m. Storing said information relating to the delivery vessel in the database, wherein the stored information relating to the delivery vessel is grouped to the load of goods;
n. Scanning, at the drop-off location, the second identification code associated with the transport container;
o. Verifying a chain of custody between the origin vessel, transport container, and delivery vessel; and
p. Sending a signal to a user device, wherein the signal is responsive to verifying the chain of custody, and wherein the signal indicates whether the chain of custody is correct.

2. The method of claim 1, further comprising the step of offloading the load of goods into the delivery vessel if the chain of custody is correct.

3. The method of claim 2, wherein the step of offloading the load of goods comprises opening a valve located on a supply line to the delivery vessel.

4. The method of claim 3, wherein the user device is located adjacent to the valve.

5. The method of claim 1, wherein the second identification code associated with the transport container identifies the goods to be offloaded into the delivery vessel.

6. The method of claim 1, wherein information stored in the database includes at least one of: an origin vessel identifier, a transport container identifier, a delivery vessel identifier, an origin vessel location, a transport container location, a transport offload hose location, a delivery vessel location, information relating to whether a delivery vessel has sufficient space in the delivery vessel to accept a load of goods therein, a chemical name, or a hazard category.

7. The method of claim 1, wherein at least one of the first, second, or third identification codes is scanned via a RFID tag.

8. The method of claim 1, wherein at least one of the first, second, or third identification codes is scanned via a global positioning system tracking device.

9. The method of claim 1, wherein at least one of the origin or delivery vessel identification codes includes global positioning system coordinates.

10. A method for delivering goods, said method comprising:
a. Storing origin vessel, delivery vessel, and transport container information in a database;
i. Said origin vessel information relating to a specific origin vessel;
ii. Said transport container information relating to a specific transport container;
iii. Said delivery vessel information relating to a specific delivery vessel;
b. Providing a unique identification code for each of the origin vessel, transport container, and delivery vessel, wherein the unique identification codes provide information relating to each of the respective origin vessel, transport container, and delivery vessel;
c. Scanning the unique identification code of the origin vessel;
d. Storing information relating to the origin vessel in the database, wherein the stored information relating to the origin vessel is grouped to a load of goods;
e. Scanning the unique identification code of the transport container;
f. Storing information relating to the transport container in the database, wherein the stored information relating to the transport container is grouped to the load of goods;
g. Loading the load of goods into the transport container from the origin vessel;
h. Transporting the load of goods in the transport container to a drop-off location where the delivery vessel is located;
i. Scanning the unique identification code of the delivery vessel;
j. Storing information relating to the delivery vessel in the database, wherein the stored information relating to the delivery vessel is grouped to the load of goods;
k. Verifying a chain of custody between the origin vessel, transport container, and delivery vessel; and
l. Sending a signal to a user device, wherein the signal is responsive to verifying the chain of custody, and wherein the signal indicates whether the chain of custody is correct.

11. The method of claim 10, further comprising the step of offloading the load of goods into the delivery vessel if the chain of custody is correct.

12. The method of claim 11, wherein the step of offloading the load of goods comprises opening a valve located on a supply line to the delivery vessel.

13. The method of claim 12, wherein the user device is located adjacent to the valve

14. The method of claim 10, wherein at least one of said identification codes is scanned via a RFID tag.

15. The method of claim 10, wherein at least one of said identification codes is scanned via a global positioning system tracking device.

16. The method of claim 10, wherein at least one of the origin or delivery vessel identification codes includes global positioning system coordinates.

17. A system, comprising:
a. a processor; and
b. a non-transitory computer-readable medium coupled to the processor and having instructions stored thereon, which, when executed by the processor, cause the processor to perform operations comprising:
i. Receiving, from a scanning device, data responsive to scanning a first identification code associated with an origin vessel, wherein information relating to the first identification code is provided and stored;
ii. Receiving, from a scanning device, data responsive to scanning a second identification code associated with a transport container, wherein information relating to the second identification code is provided and stored;
iii. Receiving, from a scanning device, data responsive to scanning a third identification code associated with a delivery vessel, wherein information relating to the third identification code is provided and stored;
iv. Verifying, by the processor, a chain of custody between the origin vessel, transport container, and delivery vessel, and
v. Sending a signal to a user device, wherein the signal is responsive to verifying the chain of custody, and wherein the signal indicates whether the chain of custody is correct.
